(19) United States
(12) Patent Application Publication
(10) Pub. No.: US 2003/0013500 A1
(43) Pub. Date: Jan. 16, 2003

(54) Cellular phone cradle with an adjustable plug-in adapter

(76) Inventors: Abe Dunoff, Cherry Hill, NJ (US); Paul Rock, Port Liberte, NJ (US)

Correspondence Address: EZRA SUTTON, P.A., Plaza 9, 900 Route 9, Woodbridge, NJ, 07095, US

(21) Appl. No.: 09/902,889

(22) Filed: Jul. 12, 2001

(51) Int. Cl. H04M 1/00

(52) U.S. Cl. 455/569; 455/570; 455/572

(57) ABSTRACT

A cellular phone cradle device for receiving a cellular phone which is detachably connected to a plug-in receptacle on the dashboard or console of a vehicle. The cellular phone cradle device includes a base cradle member having a receiving compartment for receiving a cellular phone. The base cradle member also includes interfacing electrical ports for connecting to the electrical ports of the cellular phone. A plug-in adapter is included which is detachably connected to a plug-in receptacle of a vehicle for providing power to the base cradle member and the plug-in adapter has an interior electrical connector port. A flexible extension coupling is included which is hollow and has an internal channel for receiving at least one electrical connector wire extending therethrough for electrical connection to the interior electrical connector port of the plug-in adapter, and for electrical connection to the base cradle member. The flexible extension coupling further includes a first end connected to the base cradle member and a second end connected to the plug-in adapter. The flexible extension coupling includes adjusting means having a memory for resetting it into multiple positions which are maintained until the user changes and resets the position of the coupling. This allows the user to adjust the position of the cellular phone cradle device according to the position desired by the user who is using the cellular phone in a hands-free operation.

### FIELD OF THE INVENTION

This invention relates to a cellular phone cradle having a movable and adjustable plug-in adapter that is movable relative to the user's position and the dashboard configuration of a vehicle. More particularly, the cellular phone cradle is movable to multiple positions within the dashboard area of a vehicle based upon the positioning of the flexible extension cable of the adjustable plug-in adapter.

### BACKGROUND OF THE INVENTION

The use of a cellular phone while driving in a moving vehicle is an everyday occurrence. Unfortunately, the cellular phone user must hold the phone headset to his or her ear which distracts the cell phone user's ability to operate the moving motor vehicle in a proper and safe manner and may possibly cause a vehicular accident. To avoid the aforementioned problem of the user driving an automobile while talking on a cellular phone, phone cradle devices have been developed in which the phone cradle device allows for hands-free operation of the cellular phone. The phone cradle device is mounted on either the vehicle dashboard/console or mounted on the vehicle floor. These cell phone cradle devices are electrically connected to a vehicle plug-in socket/receptacle using an adapter plug. Once mounted, these cell phone cradle devices are affixed to the vehicle and have no manuevability or movement to provide a comfortable position for the user or proper speaker amplication, as the speaker (voice receiver) of the cell phone cannot be adjusted to directly face the user/driver. Thus, the user cannot comfortably position the cell phone cradle for a proper hands-free operation of the cell phone.

There remains a need for a portable cellular phone cradle device having movable and adjustable plug-in adapter that allows for a comfortable hands-free operation of a cellular phone in a vehicle without the need for permanent installation within the vehicle. Further, the adjustable plug-in adapter should have a flexible cable in order to adjust the position of the cradle device for comfort and so that the voice receiver of the cell phone (within the cradle device) is facing the driver/user while using the cell phone in a hands-free operation.

### DESCRIPTION OF THE PRIOR ART

Cellular phone cradle devices of various designs, configurations, structures and materials of construction have been disclosed in the prior art. For example, U.S. Pat. No. 6,052,603 to Kinzalow et al discloses a cradle device for interfacing a cellular phone communication device with a radio for a hands-free operation of the cellular phone.

U.S. Pat. No. 5,847,541 to Hahn discloses a cradle device for a cellular phone that also acts as a modular power supply with an integrated battery charger.

None of the aforementioned prior art patents disclose or teach a portable cellular phone cradle device having an adjustable and flexible cable connected to a plug-in adapter in order to change the position of the cradle device for comfort and so that the voice receiver of the cell phone is facing the driver/user while using the cell phone in a hands-free operation.

Accordingly, it is an object of the present invention to provide a portable cellular phone cradle device having an adjustable and flexible plug-in adapter that allows for a comfortable hands-free operation of a cellular phone while drive in a moving vehicle.

Another object of the present invention is to provide a cellular phone cradle device that is portable and not permanently affixed to a vehicle and allows the user to easily move the cradle device from one vehicle to another.

Another object of the present invention is to provide a cellular phone cradle device that allows for multiple positioning of the cradle device which is permitted by the adjustability of the flexible extension cable of the plug-in adapter.

Another object of the present invention is to provide a cellular phone cradle device that is easy to use, light-weight and durable in construction.

A further object of the present invention is to provide a cellular phone cradle device having an adjustable and flexible plug-in adapter that can be mass produced in an automated and economical manner and is readily affordable to the cellular phone user.

### SUMMARY OF THE INVENTION

In accordance with the present invention, there is provided a cellular phone cradle device for receiving a cellular phone which is detachably connected to a plug-in receptacle on the dashboard or console of a vehicle. The cellular phone cradle device includes a base cradle member having a receiving compartment for receiving a cellular phone. The base cradle member also includes interfacing electrical ports for connecting to the electrical ports of the cellular phone. A plug-in adapter is included which is detachably connected to a plug-in receptacle of a vehicle for providing power to the base cradle member and the plug-in adapter has an interior electrical connector port. A flexible extension coupling is included which is hollow and has an internal channel for receiving at least one electrical connector wire extending therethrough for electrical connection to the interior electrical connector port of the plug-in adapter, and for electrical connection to the base cradle member. The flexible extension coupling further includes a first end connected to the base cradle member and a second end connected to the plug-in adapter. The flexible extension coupling includes adjusting means having a memory for resetting it into multiple positions which are maintained until the user changes and resets the position of the coupling. This allows the user to adjust the position of the cellular phone cradle device according to the position desired by the user who is using the cellular phone in a hands-free operation.

### BRIEF DESCRIPTION OF THE DRAWINGS

Further objects, features, and advantages of the present invention will become apparent upon the consideration of the following detailed description of the presently-preferred embodiment when taken in conjunction with the accompanying drawings, wherein:

FIG. 1 is a front perspective view of the cellular phone cradle device of the preferred embodiment of the present invention showing the base cradle member, the resettable and flexible extension coupling and the plug-in adapter in an assembled state and in operational use thereof;

FIG. 2 is a rear perspective view of the cellular phone cradle device of the present invention showing the base cradle member, the flexible extension coupling and the plug-in adapter;

FIG. 3 is a rear exploded perspective view of the cellular phone cradle device of the present invention showing the base cradle member, the flexible extension coupling and the plug-in adapter in an unassembled state being readied for operational use thereof;

FIG. 4 is a cross sectional view of the cellular phone cradle device of the present invention taken along lines 4-4 of FIG. 2 showing the cellular phone receiving compartment of the base cradle member, the internal channel of the flexible extension coupling having the pair of electrical connector wires therein, and the interior electrical connector port of the plug-in adapter;

FIG. 5 is a top plan view of the cellular phone cradle device of the present invention showing the interfacing electrical ports within the cellular phone receiving compartment of the base cradle member, the flexible extension coupling and the plug-in adapter; and

FIG. 6 is a perspective view of the cellular phone cradle device of the present invention showing an alternate flexible extension coupling having double-sided adhesive tape encircling each of the connector members thereon.

### DETAILED DESCRIPTION OF THE PREFERRED EMBODIMENT

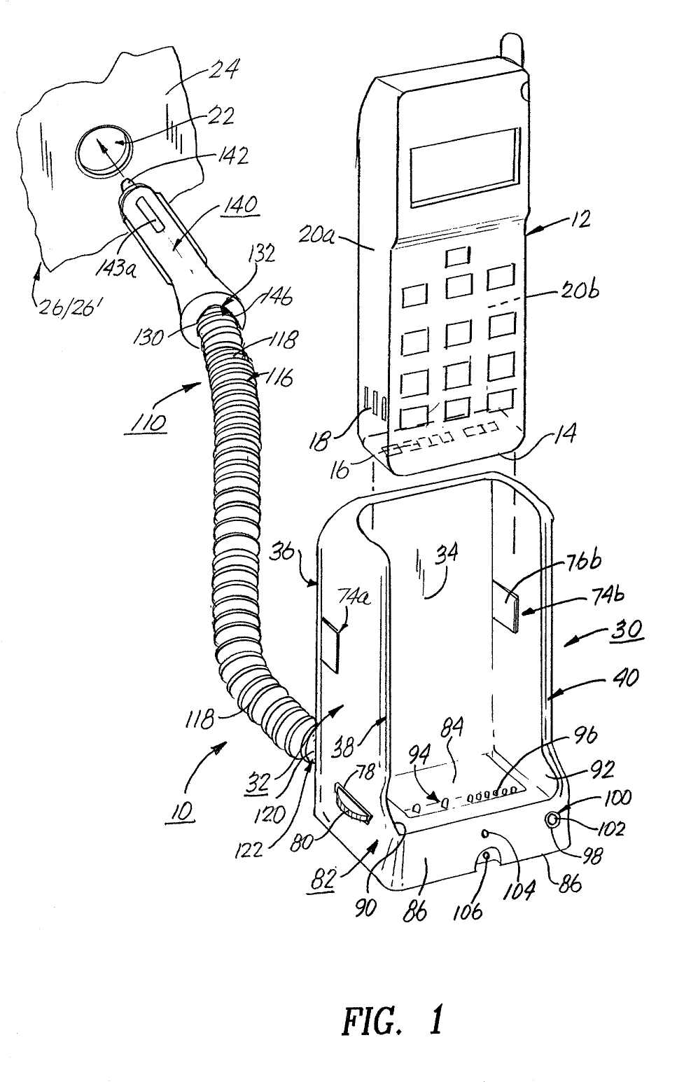

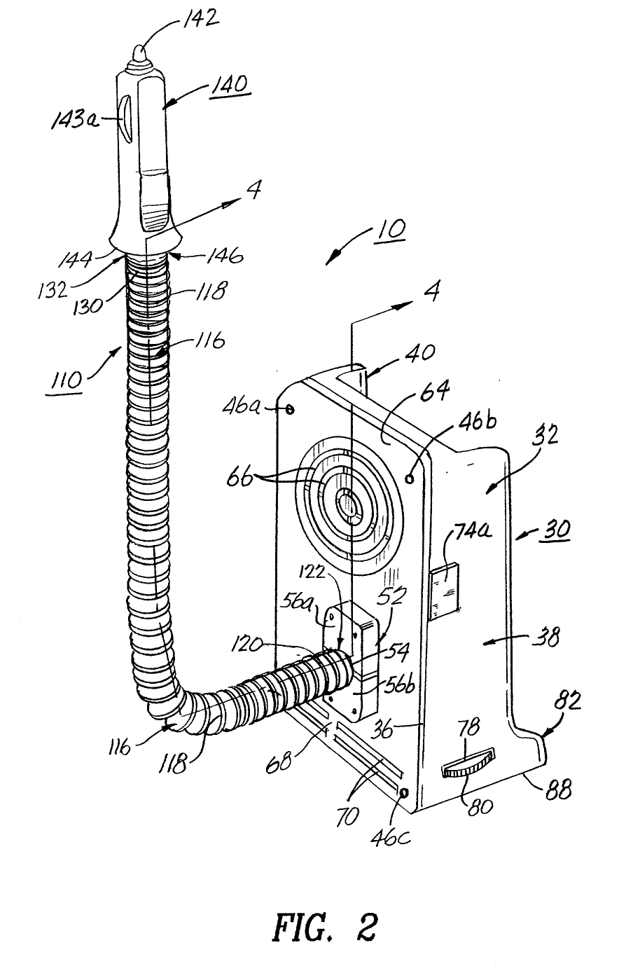

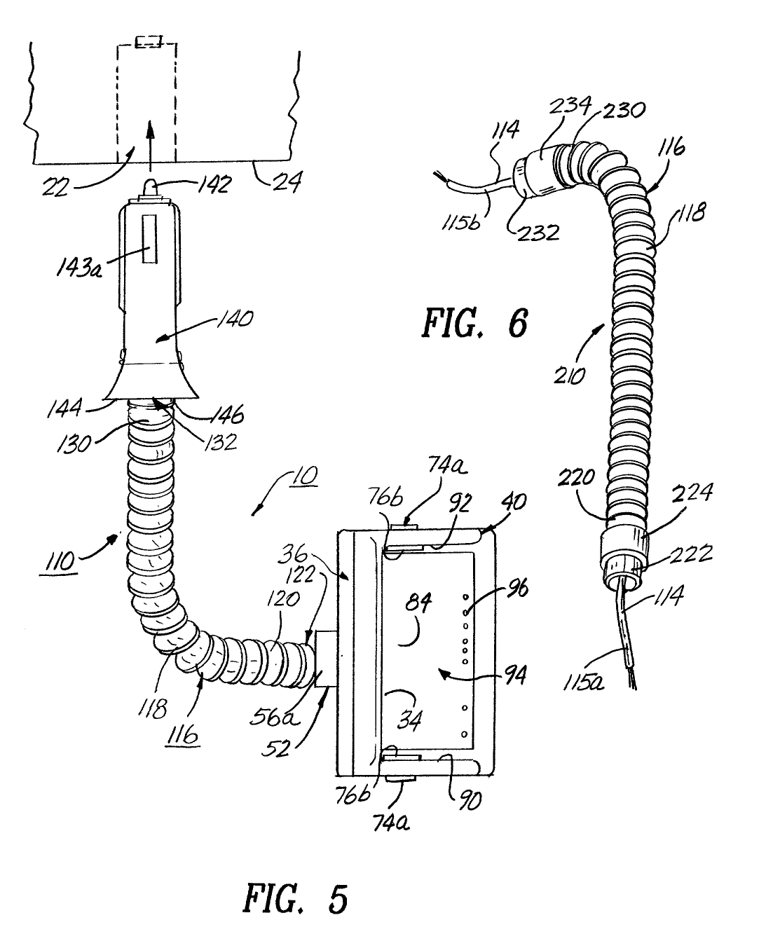

The cellular phone cradle device 10 and its component parts of the preferred embodiment of the present invention are represented in detail by FIGS. 1 through 5 of the patent drawings. The cellular phone cradle device 10 is used for receiving a cellular phone 12 therein and for detachably connecting it to a plug-in receptacle/socket 22 on the console or dashboard 24 of a vehicle 26, as depicted in FIG. 1. The cellular phone cradle device 10, as shown in FIGS. 2 to 4, includes a base cradle member 30 having a cellular phone receiving compartment 90 with interfacing electrical ports 92 thereon, a resettable and hollow flexible extension coupling 110 having an internal channel 112 for receiving the electrical connector wires 114 therethrough, and a plug-in adapter 80.

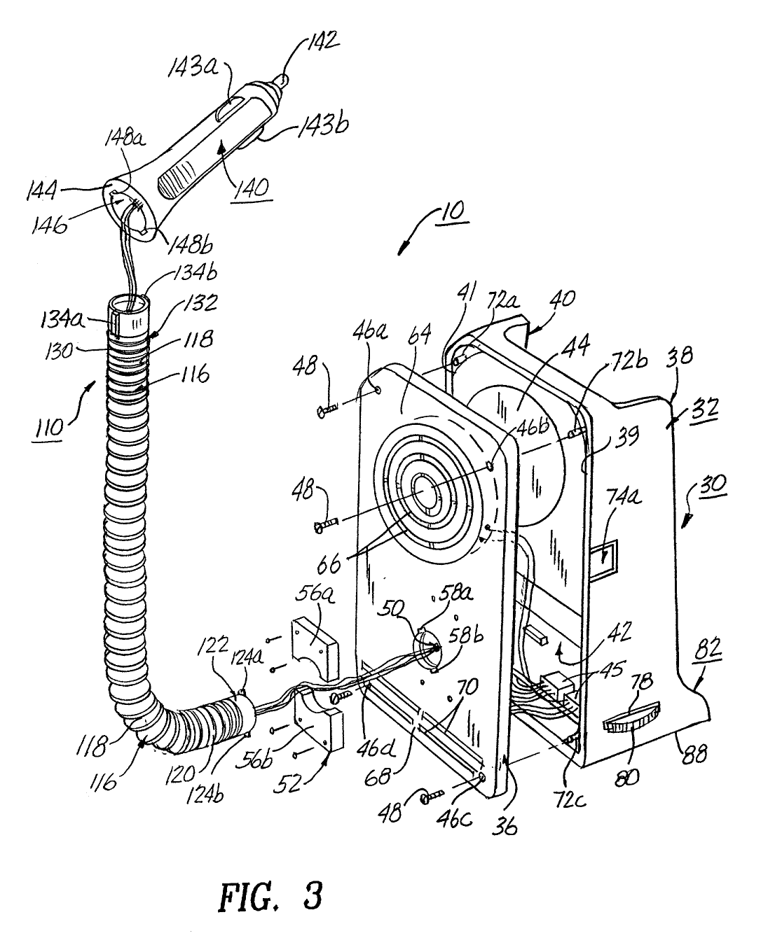

The base cradle member 30, as shown in FIGS. 3 to 5, has a substantially L-shaped configuration and includes a vertical wall section 32 and an integrally connected horizontal wall section 82. The vertical wall section 32 includes an inner wall surface 34, a detachable outer rear wall section 36, and side wall sections 38 and 40 for forming an interior compartment 42 for receiving a voice speaker member 44 and other electronic elements 45 for operating the cellular phone cradle device 10. Rear wall section 36 includes a plurality of attachment openings 46a, 46b, 46c and 46d for receiving mounting screws 48 therein. Rear wall section 36 further includes a connector wire opening 50 and a detachable connector support member 52 therein having an opening 54 for receiving a first snap connector member 122 therein. Connector support member 52 includes a pair of connecting arc-section members 56a and 56b for forming opening 54. Opening 50 includes a pair of opposing interior slotted channels 58a and 58b within the side perimeter edge 51 of opening 50 on rear wall section 36. Opening 54 of connector support member 52 is aligned and adjacent to connector wire opening 50 of rear wall section 36. Connector wire opening 50 includes an interior electrical connector wire opening 60 for receiving the first end 115a of connector wires 114. Outer rear wall section 36 at its upper end 64 includes a plurality of concentric circular slotted openings 66 for voice speaker member 44, and at its lower end 68 a plurality of horizontal venting slots 70 for venting any excess heat from the base cradle member 30.

Each of the side wall sections 38 and 40 includes side wall edges 39 and 41 having mounting openings 72a, 72b, 72c and 72d, respectively, therein. Mounting openings 72a to 72d are aligned and adjacent to the attachment openings 46a to 46d for receiving mounting screws 48 therein, respectively, for detachably attaching the rear wall section 36 to the side wall sections 38 and 40, respectively, for forming the vertical wall section 32 of base cradle member 30. Each of the side wall sections 38 and 40 further includes a pair of releasable grabbing members 74a and 74b, respectively, thereon. Each of the releasable grabbing members 74a and 74b include holding pads 76a and 76b, respectively, which are used for holding the cellular phone 12 in an upright position. Each of the releasable holding pads 76a and 76b, respectively, are used for holding the side walls 20a and 20b of cellular phone 12 thereto. Side wall section 38 also includes a rectangular slot opening 78 for receiving a volume control disk 80 for controlling the voice volume of the voice speaker member 44.

The horizontal wall section 82 includes a top wall surface 84, a front wall surface 86, a bottom wall surface 88 and side wall surfaces 90 and 92. Top wall surface 84 includes a phone receiving compartment 94 having interfacing electrical ports 96 thereon, as shown in FIGS. 1, 3 and 5 of the drawings. Front wall surface 86 includes a first electrical opening 98 for receiving a red power indicator light 100 and lens 102 thereto, a second electrical opening 104 for receiving an ear microphone (not shown), and a third electrical opening 106 for receiving a voice microphone (not shown).

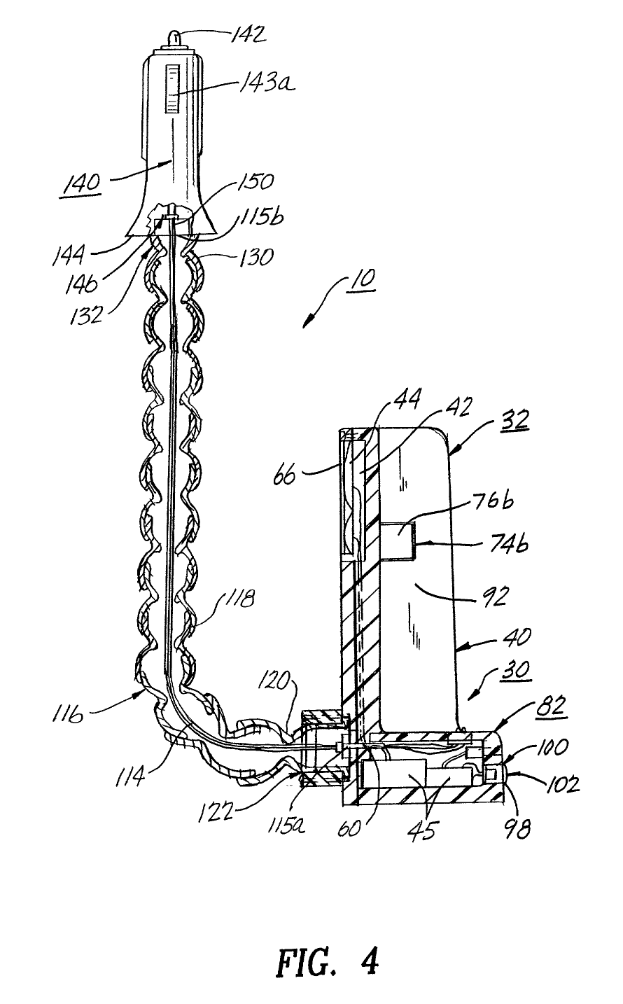

The flexible extension coupling 110, as shown in FIGS. 3 and 4 of the drawings, includes an internal channel 112 for retaining electrical connector wires 114 extending therethrough. Flexible extension coupling 110 further includes a first end 120 having a snap-in connector member 122 attached thereto. Snap-in connector member 122 includes a pair of opposing tab components 124a and 124b thereon for connecting with the opposing pair of slotted channels 58a and 58b of opening 50 of the rear wall 36 being attached to the base cradle member 30, respectively. The flexible extension coupling 110 also includes a second end 130 having a snap-in connector member 132 attached thereto. Snap-in connector member 132 includes a pair of opposing tab components 134a and 134b thereon for connecting with the opposing pair of slotted channels 148a and 148b of end wall opening 146 of the plug-in adapter 140, respectively. Additionally, the extension coupling 110 includes adjusting means 116 for allowing multiple positioning of the coupling 110 by the user, as depicted in FIGS. 1, 2 and 5 of the drawings. Adjusting means 116 includes an outer spine or cover 118 that may be moved to multiple positions or configurations which are maintained until changed as the cover 118 has memory. The flexible coupling spine 118 of the cradle device 10 enables the extension coupling 110 to be bent, coiled or wrapped into various positions for the convenience and comfort of the user, and it retains those positions until the user moves it into a new position or configuration.

FIG. 6 shows an alternate embodiment of a hollow and flexible coupling 210 which may be substituted and used for connecting to the base cradle member 30 and for connecting to the plug-in adapter 140 of the cellular phone cradle device 10. Flexible extension coupling 210 includes a first end 220 having a connector member 222 attached thereto, and a second end 230 having a connector member 232 attached thereto. Connector member 222 includes a double-sided adhesive tape 224 which encircles the connector member 222. The double-sided adhesive tape 224 of connector member 222 is used to attach itself within openings 52 and 50 of the connector support member 52 and rear wall 36, respectively, of the base cradle member 30. Connector member 232, also includes a double-sided adhesive tape 234 which encircles the connector member 232. The double-sided adhesive tape 234 of connector member 232 is used to attach itself within end wall opening 146 of the plug-in adapter 140.

The flexible extension couplings 110 or 210 have a diameter in the range of a ½ inch to ¾ inches, a wall thickness in the range of 1/32 of an inch to ⅛ of an inch, and a length in the range of 2 inches to 6 inches.

The internal channel 112 is used for receiving the electrical connector wires 114 extending therethrough. The electrical connector wires 114 include a first end 115a for electrically connecting to the interfacing electrical ports 96 within the cellular phone receiving compartment 94 of the base cradle member 30, and a second end 115b for electrically connecting to the interior electrical connector port 150 within the end wall opening 146 of end wall 144 of the plug-in adapter 140, as shown in FIG. 4 of the drawings.

Plug-in adapter 140, as shown in FIGS. 2 to 5, includes an electrical contact member 142 for electrically contacting the plug-in socket 22 of vehicle 26 in order to supply electrical power to the base cradle member 30 and a pair of retaining ribs 143a and 143b for retaining the plug-in adapter 140 within the plug-in socket 22. Plug-in adapter 140 also includes an end wall 144 having an end wall opening 146 therein. End wall opening 146 includes a pair of opposing slotted channels 148a and 148b for receiving and connecting with the pair of opposing tab components 134a and 134b of snap-in connector member 130, respectively, of the flexible extension coupling 110. Additionally, wall end opening 146 includes an interior electrical connector port 150 therein for electrically connecting with the second end 115b of connector wires 114, as depicted in FIG. 4 of the drawings.

Base cradle member 30 is made of moldable, light-weight and durable plastic materials. Extension coupling 110 is also made of moldable, light-weight, flexible and durable plastic materials.

### OPERATION OF THE INVENTION

In using the cellular phone cradle device 10 of the present invention, the user/driver simply inserts the plug-adapter 140 into the cigarette plug-in receptacle 22 on the console or dashboard area 24 of vehicle 26. The electrical contact member 142 is electrically connected to plug-in receptacle 22 and provides electrical power from the vehicle's battery (not shown) to the base cradle member 30.

The user now bends or shapes or wraps the outer spine 118 of flexible extension coupling 110 into a desired position which is comfortable to use. The final position of flexible extension coupling 110 is dependent upon the configuration of the console or dashboard area 24 or front seating area of vehicle 26. For maximum efficiency, spine 118 is configured so that the base cradle member 30 is positioned to face the driver/user while using the cellular phone 12 in a hands-free operation. Flexible coupling 110 has memory and maintains its position until it is changed and reset to a new position or configuration.

In the final step, the user now inserts the base 14 of cellular phone 12 within the receiving compartment 94 of base cradle member 30 such that the electrical receiving ports 16 of cellular phone 12 are electrically connected with that of the interfacing electrical ports 96 of receiving compartment 94 in order for cellular phone 12 to accept the electrical power from plug-in socket 22 of vehicle 26. Any final adjustments can still be made by further reshaping or bending of the flexible extension coupling 110 to reposition the base cradle member 30 such that the voice receiver member 18 of the cell phone 12 (now located within the cradle device 10) is facing the driver/user while using the cell phone 12 in a hands-free operation. Also, the user may reposition the cradle device 10 to optimally position the base cradle member 30 to the configuration of vehicle 26.

Additionally, since the cellular phone cradle device 10 is not permanently affixed to vehicle 26, the user has the ability to easily remove cradle device 10 from one vehicle 26 and reinstall the cradle device 10 in another vehicle 26′. The user then repeats the aforementioned steps to optimally position the cradle device 10 for the convenience and use of his/her cellular phone 12 when driving the motor vehicle 26 or 26′ while using the cellular phone 12 in a hands-free operation.

### ADVANTAGES OF THE PRESENT INVENTION

Accordingly, an advantage of the present invention is that it provides for a portable cellular phone cradle device having an adjustable and flexible plug-in adapter that allows for a comfortable hands-free operation of a cellular phone while drive in a moving vehicle.

Another advantage of the present invention is that it provides for a cellular phone cradle device that is portable and not permanently affixed to a vehicle and allows the user to easily move the cradle device from one vehicle to another.

Another advantage of the present invention is that it provides for a cellular phone cradle device that allows for multiple positioning of the cradle device which is permitted by the adjustability of the flexible extension cable of the plug-in adapter.

Another advantage of the present invention is that it provides for a cellular phone cradle device that is easy to use, light-weight and durable in construction.

A further advantage of the present invention is that it provides for a cellular phone cradle device having an adjustable and flexible plug-in adapter that can be mass produced in an automated and economical manner and is readily affordable to the cellular phone user.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A cellular phone cradle device for receiving a cellular phone and for detachably connecting said device to a plug-in receptacle on the dashboard or console of a vehicle, comprising:
a) a base cradle member having a receiving compartment for receiving a cellular phone; said base cradle member having interfacing electrical ports for connecting to the electrical ports of the cellular phone;
b) a plug-in adapter for detachably connecting said base cradle member to a plug-in receptacle of a vehicle for providing power to said base cradle member; said plug-in adapter having an interior electrical connector port;
c) a hollow and flexible extension coupling having an internal channel for receiving at least one electrical connector wire extending therethrough for electrical connection to said electrical ports of said base interior electrical connector port of said plug-in adapter and for electrical connection to said base cradle member;
d) said flexible extension coupling including a first end connected to said base cradle member and a second end connected to said plug-in adapter; and
e) said flexible extension coupling including adjusting means having a memory for resetting said coupling into multiple positions which are maintained until the user changes and resets the position of said coupling in order to adjust the position of said cellular phone cradle device according to the position desired by the user in using the cellular phone in a hands-free operation.

2. A cellular phone cradle device in accordance with claim 1, wherein said adjusting means for providing multiple positions includes an outer spine having memory for setting and maintaining a specific position of said flexible extension coupling relative to said base cradle member until it is changed by the user.

3. A cellular phone cradle device in accordance with claim 1, wherein said base cradle member is made of moldable, light-weight and durable plastic materials.

4. A cellular phone cradle device in accordance with claim 1, wherein said flexible extension coupling is made of moldable, light-weight, flexible and durable plastic materials.

5. A cellular phone cradle device in accordance with claim 1, wherein said flexible extension coupling has a diameter in the range of ½ inch to ¾ inches, a wall thickness in the range of 1/32 of an inch to ⅛ of an inch, and a length in the range of 2 inches to 6 inches.

6. A cellular phone cradle device in accordance with claim 1, wherein said first end of said flexible extension coupling includes a first snap-in connector member, and said second end of said flexible extension coupling includes a second snap-in connector member.
